(19) United States
(12) Patent Application Publication
(10) Pub. No.: US 2019/0295424 A1
(43) Pub. Date: Sep. 26, 2019

(54) METHOD AND SYSTEM FOR ASSISTING AN OPERATOR IN CREATING A FLIGHT PLAN OF AN AIRCRAFT PASSING THROUGH A SET OF MISSION ZONES TO BE COVERED

(71) Applicant: THALES, COURBEVOIE (FR)

(72) Inventors: Guillaume DUPONT, MERIGNAC (FR); David ARNEAU, MERIGNAC (FR); Ludovic BILLAULT, MERIGNAC (FR)

(21) Appl. No.: 16/355,503

(22) Filed: Mar. 15, 2019

(30) Foreign Application Priority Data
Mar. 22, 2018 (FR) 1800241

(51) Int. Cl. G08G 5/00; G01C 23/00

(52) U.S. Cl. CPC G08G 5/0034; G01C 23/005; G08G 5/006

(57) ABSTRACT

A method for assisting an aeronautical operator in the creation of a flight plan of an aircraft passing through a set of predetermined geographic mission zones includes a step of determination, for each mission zone, of an entry access point and an exit access point of the mission zone, the entry and exit access points associated with a mission zone being able to be separate or merged; and a step of determination of an interzone path from an entry access point to an exit access point of the set of the mission zones which connects, in series and without loop, all the mission zones by their entry and exit access points, and the length of which is minimal.

### CROSS-REFERENCE TO RELATED APPLICATIONS

This application claims priority to foreign French patent application No. FR 1800241, filed on Mar. 22, 2018, the disclosure of which is incorporated by reference in its entirety.

### FIELD OF THE INVENTION

The present invention relates to a method and a system for assisting an operator in creating a flight plan of an aircraft passing through a set of geographic mission zones to be covered.

### BACKGROUND

The invention lies within the framework of an aeronautical mission(s) application that can be performed by an avionics computer embedded on board an aircraft with or without a pilot, for example a computer of a flight management system FMS, or an unmanned aircraft ground control station GCS, or by a touch tablet, for example of EFB (electronic flight bag) type, or by aeronautical mission preparation software.

The main aeronautical missions targeted in the invention are each executed in a specific geographic zone and are, for example, in a given geographic mission zone, search and rescue missions, or land or sea surveillance missions, or communication relay missions between two actors when these actors are situated in geographic mission zones which cannot be linked for geographic reasons, for example mountains or expanses of water forming obstacles, but can be, more generally, any type of mission that has to be performed in a determined geographic zone.

Up until now, the flight plan of an aircraft has been constructed manually by the operator, i.e. the pilot or the mission manager, through a dedicated human-machine interface, for example a multipurpose control display unit MCDU, ARINC 661, or a tactical console, by positioning, one by one, all the points of the flight plan, i.e. the way points WPT on the geographic mission zones with a predetermined order of travel. The positioning of the points and their order of travel result from a prior estimation of a best path joining the different mission zones, performed by the pilot without outside assistance by a computer.

Such positionings are described for example in the U.S. Pat. No. 8,275,499 B2 and the patent application WO 2009093276 A1.

However, this procedure does not guarantee that the path between the mission zones, estimated beforehand by the operator and refined by the flight management system FMS, is always the shortest, and presents the drawback that any modification of the mission plan, following the addition of a new mission zone or the modification of an existing mission zone or the deletion of a mission zone necessitates the manual reworking of the flight plan by the operator, which consequently increases the work load of the operator.

A first technical problem is how to provide a method and a system for assisting the operator which creates, simply, rapidly and accurately, a flight plan of an aircraft passing through a set of predetermined geographic mission zones and the overall spatial interzone path of which is made minimal.

A second technical problem is how to provide a method and a system for assisting the operator that makes it possible to rapidly recalculate a flight plan that is optimized in terms of interzone path distance when the set of the zones is modified by the addition of a mission zone, the deletion of a mission zone or the modification of an existing mission zone.

A third technical problem, associated with the first and second technical problems, is how to avoid the use of the resources of a flight computer of high security level, for example a computer of FMS type.

### SUMMARY OF THE INVENTION

To this end, the subject of the invention is a method for assisting an aeronautical operator in the creation of a flight plan of an aircraft passing through a set of predetermined geographic mission zones, implemented by an operator assistance system comprising an electronic assistance computer, an associated human-system the interface IHS and a database, the method for assisting in the creation of the flight plan comprising a preliminary first step in which there is supplied a set of at least two separate geographic mission zones, characterized geometrically by their convex forms and their placement in a two-dimensional geographic reference frame, and there are supplied, in the same reference frame, the geographic coordinates of an entry access point and of an exit access point of the set of the mission zones, the entry and exit access points of the set being separate from each of the mission zones. The method for assisting in the creation of the flight plan is characterized in that it comprises a set of steps consisting in:

in a second step, determining, respectively for each mission zone, an entry access point and an exit access point of the mission zone, the entry and exit access points associated with a mission zone being able to be separate or merged; then

in a third step, determining an interzone path from the entry access point to the exit access point of the set of the mission zones which connects, in series and without loop, all the mission zones by their entry and exit access points, and the length of which is minimal.

According to particular embodiments, the method for assisting an aeronautical operator in the creation of a flight plan of an aircraft comprises one or more of the following features, taken in isolation or in combination:

the total number of mission zones is an integer number N greater than or equal to 2, and the interzone path the length of which is minimal is configured to link, in a chain, the entry access point of the set of the mission zones to the exit access point of the set of the mission zones through a succession of N−1 intermediate segments linking in series the N mission zones without looping back to a mission zone from their respective entry access point to their respective exit access point; and the third step uses a shorter path algorithm passing through all the entry and exit points of the mission zones, determined in the second step from the entry access point of the set of the mission zones to the exit access point of the set of the mission zones;

the shorter path algorithm is included in the set of the algorithms formed by the “brute force” algorithm, and the genetic algorithms, and the “ant colonies” algorithm and the nearest neighbor algorithm.

the total number of mission zones is an integer number N greater than or equal to 2, and each mission zone identified by an identification index i, i varying from 1 to N, has a polygonal form having a number of sides nᵢ and a number of vertices nᵢ,

the set of the mission zones comprises at least one mission zone of first type having an entry access point and an exit access point that are different which are situated both on the outline of said mission zone of first type, or both within said mission zone of first type, or, for one, on the outline of said mission zone of first type and, for the other, within said mission zone of first type;

each zone of first type comprises an open internal pattern of travel of the aircraft from the entry access point to the exit access point of said mission zone of first type;

the open pattern of at least one mission zone of first type is composed of successive segments and/or has a form of a curve oscillating about a main direction or a form of a spiral curve;

the set of the mission zones comprises at least one mission zone of second type having a same entry and exit access point, the entry and exit access point being situated within said mission zone of second type or on the outline of said mission zone of second type;

each mission zone of second type has a convex polygonal form, and the entry and exit access point of said zone of second type is situated within said mission zone and is the isobaric center of the vertices of its outline polygon;

each mission zone of second type comprises a closed internal pattern of travel of the aircraft starting from the single access point serving as entry and returning to the single access point serving as exit of said mission zone of second type;

the closed internal pattern of at least of at least one mission zone of second type is composed of successive segments and/or has a form of a set of an integer number, greater than or equal to 2, of lobes distributed angularly over a segment of limited or omnidirectional angular aperture;

the total number of mission zones is an integer number N greater than or equal to 2, and all the mission zones are mission zones of first type each having an entry access point and an exit access point that are different which are situated both on the outline of said mission zone of first type, or both within said mission zone of first type, or, for one, on the outline of said mission zone of first type and, for the other, within said mission zone of first type;

the total number of mission zones is an integer number N greater than or equal to 2, and all the mission zones are mission zones of second type having, for each, a different entry and exit access point, the entry and exit access point of any mission zone of second type being situated within said mission zone of second type or on the outline of said mission zone of second type;

the above method further comprises a fourth step of display, in which a display displays the flight plan determined in the third step, and/or a fifth step in which the flight plan, determined in the third step, is transferred to a flight management system having a high security level.

Another subject of the invention is a system for assisting an aeronautical operator in the creation of a flight plan of an aircraft passing through a set of predetermined geographic mission zones, comprising an electronic assistance computer for the aeronautical operator, an associated human-system interface IHS, and a database; the database and/or the human-system interface being configured to, in a preliminary first step, supply the electronic assistance computer with a set of at least two separate geographic mission zones, characterized geometrically by their convex forms and their placement in a two-dimensional geographic reference frame, and supply, in the same reference frame, the geometrical coordinates of an entry access point and of an exit access point of the set of the mission zones, the entry and exit access points of the set being separate from each of the mission zones. The system for assisting the aeronautical operator in the creation of a flight plan is characterized in that the electronic assistance computer and/or the database is or are configured to, in a second step, determine, respectively for each mission zone, an entry access point and an exit access point of the mission zone, the entry and exit access points associated with a mission zone being able to be separate or merged; and the electronic assistance computer is configured to, in a third step following the first and second steps, determine an interzone path from the entry access point to the exit access point of the set of the mission zones which connects, in series and without loop, all the mission zones by their entry and exit access points, and the length of which is minimal.

According to a particular embodiment, the system for assisting an aeronautical operator in the creation of a flight plan of an aircraft comprises one or more of the following features:

the human-system interface is configured to, in a fourth step, display through a display the flight plan determined in the third step, and/or the assistance computer is configured to, in a fifth step, transfer the flight plan, determined in the third step, to a flight management system having a high security level.

### BRIEF DESCRIPTION OF THE DRAWINGS

The invention will be better understood on reading the following description of several embodiments, given purely by way of example and made with reference to the drawings in which:

FIG. 1 is a view of an example of a system for assisting in the creation of a flight plan of an aircraft according to the invention, said assistance system cooperating in particular with a flight management system of the aircraft;

FIG. 2 is a flow diagram of a method for assisting in the creation of a flight plan according to the invention, said assistance method being implemented by the system for assisting in the creation of a flight plan of FIG. 1;

FIG. 3 is a first example of a flight plan of an aircraft corresponding to a first configuration of a set of mission zones for which the interzone path is minimal, determined and supplied by the assistance method according to the invention of FIG. 2;

FIGS. 4A and 4B are respective examples of views of a mission zone of a first type and of a mission zone of a second type;

FIG. 5 is a second example of a flight plan of an aircraft corresponding to a second configuration of a set of mission zones for which the interzone path is minimal, determined and supplied by the assistance method of FIG. 2;

FIG. 6 is a third example of a flight plan of an aircraft corresponding to a third configuration of a set of mission zones for which the interzone path is minimal, determined and supplied by the assistance method of FIG. 2;

FIGS. 7A, 7B, 7C, 7D are, respectively, views of first, second, third, fourth embodiments of an internal pattern of a mission zone of first type;

FIGS. 8A, 8B are, respectively, views of first and second embodiments of an internal pattern of a mission zone of second type;

FIG. 9 is a flow diagram of a particular embodiment of the assistance method according to the invention of FIG. 2, in which the step of determination of an interzone path of minimal length uses an algorithm of “nearest neighbor” type;

FIGS. 10A and 10B are illustrations of two intermediate paths determined successively by the third step of determination of an interzone path of minimal length, part of the assistance method of FIG. 9.

### DETAILED DESCRIPTION

The method for assisting in the creation of a flight plan according to the invention is based on the use of an electronic computer which allows the aeronautical operator to focus only on the different missions that he or she has to perform and avoids him or her having to perform the phase of manual input of a flight plan, of a mission the interzone trajectory of which is estimated by the operator himself or herself as producing the shortest path linking the different mission zones to be traveled.

The assistance method according to the invention is founded on the use of a database of mission type in which the geometry of geographic mission zones is specified.

According to FIG. 1, a system for assisting or aiding 2 an aeronautical operator in the creation of a flight plan of an aircraft passing through a set of predetermined geographic mission zones comprises an electronic computer 4 for assisting the aeronautical operator in the creation of the flight plan, a database 6, associated with and connected to the electronic computer 4, and containing geometrical characteristics of geographic mission zones, and a human-system interface IHS 8.

The database 6 is configured to, in a preliminary first step, supply the electronic assistance computer 4 with a set of at least two separate geographic mission zones, characterized geometrically by their convex forms and their placement in a two-dimensional geographic reference frame, and to supply the geometric coordinates of an entry access point and of an exit access point of the set of the mission zones, the entry access point Pe0 and exit access point Ps0 of the set of the mission zones being separate from each of the mission zones.

The geographic mission zones are each defined by a different outline having a convex form and are separate, that is to say unconnected or without an overlap between them, taken two by two.

The entry access point Pe0 and exit access point Ps0 of the set of the mission zones are separate from each of the mission zones, that is to say they are situated outside of each of the mission zones.

The human-system interface IHS 8 and/or the assistance computer 4 is or are configured to, in a second step, determine, respectively for each mission zone, an entry access point and an exit access point of said mission zone, the entry and exit access points associated with a mission zone being able to be separate or merged.

The total number of mission zones being designated by an integer number N greater than or equal to 2, and, for each mission zone assumed identified uniquely by an identification index i, i varying from 1 to N, the entry access point of the mission zone i and the exit access point of the mission zone “i” are designated respectively by Pei and Psi.

The electronic assistance computer 4 is configured to, in a third step, following the first and second steps, determine an interzone path, starting from the entry access point Pe0 and going to the exit access point Ps0 of the set of the mission zones, which connects, in series and without loop, all the mission zones by their entry and exit access points Pei, Psi, i varying from 1 to N, and the length of which is minimal.

The human-system interface 8 is configured to, in a fourth step, display, through a display 12, the flight plan determined in the third step, and/or the electronic assistance computer 4 is configured to, in a fifth step, transfer the flight plan, determined and calculated in the third step by the electronic assistance computer 4, to a flight management system 16 having a high security level, for example an FMS system (flight management system).

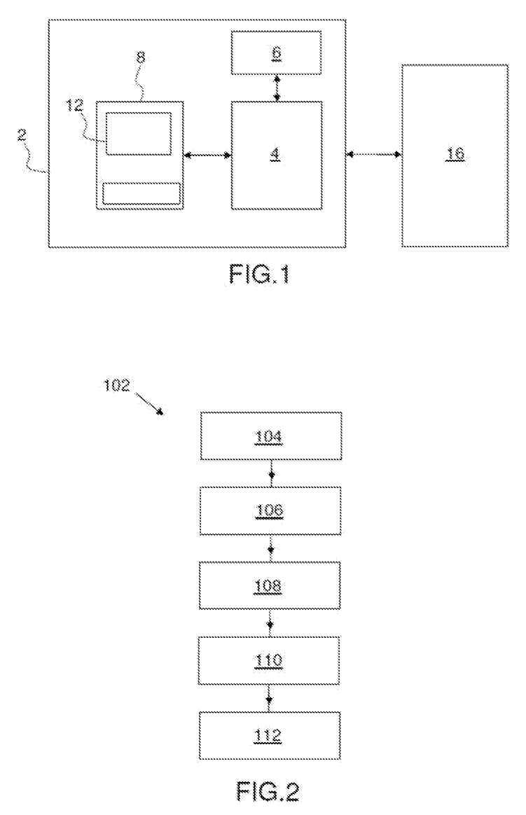

According to FIG. 2, a method for assisting or aiding 102 an aeronautical operator in the creation of a flight plan of an aircraft, passing through a set of predetermined geographic mission zones and for which the length of the interzone path is the shortest, is implemented for example by the operator assistance system 2 described in FIG. 1.

The method for assisting in the creation of the flight plan comprises, generally, a set of at least three steps 104, 106, 108.

In the first step 104, geometrical characteristics of a set of at least two geographic mission zones separate from one another, taken two by two, are supplied first to the electronic assistance computer 4 through the database 6.

The geographic mission zones of the set of the mission zones are characterized geometrically by their convex forms and their placement in a two-dimensional geographic reference frame.

The main aeronautical missions, executed in the geographic mission zones, are for example search and rescue missions, or land or sea surveillance missions, or communication relay missions between two actors when these actors are situated in geographic zones which cannot be linked for geographic reasons, for example mountains or expanses of water forming obstacles, but can be, more generally, any type of mission having to be performed in a determined geographic zone.

During the same first step 104, the operator supplies the electronic computer 4, through the human-system interface IHS 8 and in the same geographic reference frame, with the geometrical coordinates of an entry access point Pe0 and of an exit access point Ps0 of the set of the mission zones i, i varying from 1 to N, the entry and exit access points Pe0, Ps0, of the set being separate from each of the mission zones i, i varying from 1 to N.

Then, in the second step 106, the database 6 and/or the human-system interface IHS 8 and/or the computer determine/determines, respectively for each mission zone i, i varying from 1 to N, an entry access point Pei and an exit access point Psi of the geographic mission zone i, the entry and exit access points Pei, Psi associated with a mission zone being able to be separate or merged.

Next, in a third step 108, the electronic assistance computer 4 determines an interzone path from the entry access point Pe0 to the exit access point Ps0 of the set of the mission zones which connects, in series and without loop, all the mission zones by their entry and exit access points, Pei, Psi, i varying from 1 to N, and the length of which is minimal.

The method 102 for assisting in the creation of a flight plan further comprises, optionally, a fourth step 110 and/or a fifth step 112.

In the fourth step 110, the human-system interface 8 is configured to display, through the display 12, the mission flight plan determined in the third step 108.

In the fifth step 112, the electronic assistance computer 4 transfers the flight plan, determined in the third step 108 by the electronic assistance computer 4, to the flight management system 16 having a high security level, for example an FMS system (flight management system).

The algorithm of shorter path passing through all the entry and exit points Pei, Psi, of all the mission zones i, i varying from 1 to N, used in the third step 108, is included in the set of algorithms formed by the “brute force” algorithm, the genetic algorithms, the “ant colonies” algorithm and the “nearest neighbor” algorithm.

These algorithms are algorithms for solving the problem known as “commercial traveler problem” and take into account the direction of travel of the mission zones for each of which the entry access point Pei must always precede the exit access point Psi. These algorithms address the “commercial traveler problem”, with more or less accurate results. Thus, the so-called “brute force” algorithm which calculates all the possible path combinations is very accurate but very costly in terms of computation time, and can thus be used only for a low number of mission zones.

The number of mission zones and the execution time and the accuracy of the response, taken alone or in combination, can be criteria of choice of the algorithm. Nevertheless, all these algorithms can be used for the implementation of the third step 108.

In particular, each mission zone i, i varying from 1 to N, can have a complex polygonal form having a number of sides nᵢ and a number of vertices nᵢ.

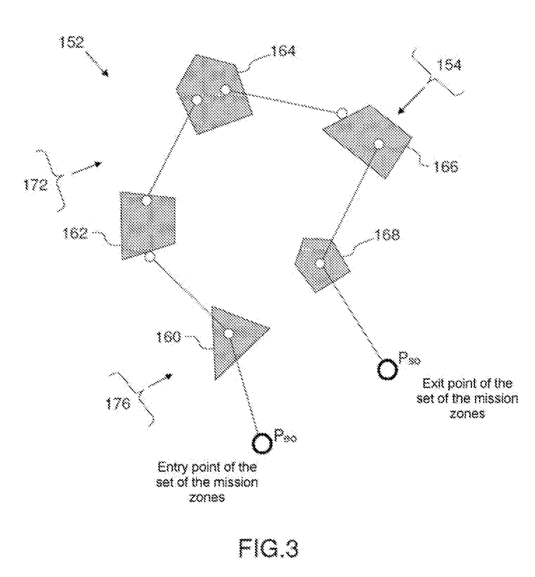

According to FIG. 3, a first example of a flight plan 152 of an aircraft for which the interzone path is minimal, determined and supplied by the assistance method 102 of FIG. 2, comprises a set 154 of mission zones 160, 162, 164, 166, 168 the composition of which in terms of type of mission zones is representative of a first configuration in which the set 154 of the mission zones can be broken down into a first non-empty subset 172 of mission zones of first type 162, 164, 166, and a second non-empty subset 176 of mission zones of second type 160, 168.

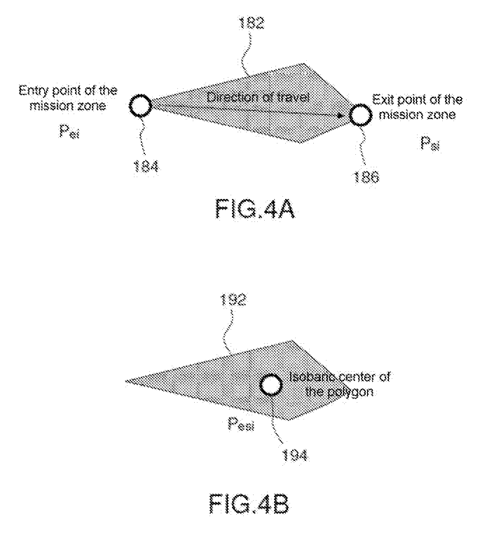

According to an example of FIG. 4A, a zone of first type 182 is a mission zone which has an entry access point 184 Pei via which the aircraft enters and an exit access point 186 Psi via which the aircraft exits, that are distinct and identified precisely, an external overall direction of travel being defined from the entry access point 184 Pei to the exit access point 186 Psi. Such points correspond, for example, in the context of a maritime surveillance mission tracking an ocean current the curved trajectory of which is unimportant and in which only the entry and exit points are important.

According to an example of FIG. 4B, a zone of second type 192 is a mission zone which has a single access point 194 forming both the entry access point and the exit access point of the mission zone of second type. Such an access point corresponds, for example, to missions of search and rescue type in “sector” mode in which the entry and exit access points of the mission zone are reduced to a single point Pesi which can be equal, for example, to the isobaric center of a polygon defining and modeling the mission zone. In this case, the single entry and exit access point Pesi is determined by a calculation and stored before the execution of the third step.

According to FIG. 5, a second example of a flight plan 202 of an aircraft for which the interzone path is minimal, determined and supplied by the assistance method 102 of FIG. 2, comprises a set 204 of first, second, third, fourth, fifth mission zones 210, 212, 214, 216, 218, the composition of which in terms of type of mission zones is representative of a second configuration in which the set 204 is all composed of mission zones 210, 212, 214, 216, 218 of first type.

All the mission zones 210, 212, 214, 216, 218 of first type each have an entry access point 220, 224, 228, 232, 236 and an exit access point 222, 226, 230, 234, 238 that are different.

The entry access point 220 and the exit access point 222 are both situated on the outline of the first mission zone 210 of first type. Likewise, the entry access point 232 and the exit access point 234 are both situated on the outline of the fourth mission zone 216 of first type.

The entry access point 228 and the exit access point 230 are both situated within the third mission zone 214 of first type.

The entry access point 224 is situated on the outline of the second mission zone 212 of first type and the exit access point 226 is situated within the second mission zone 212 of first type.

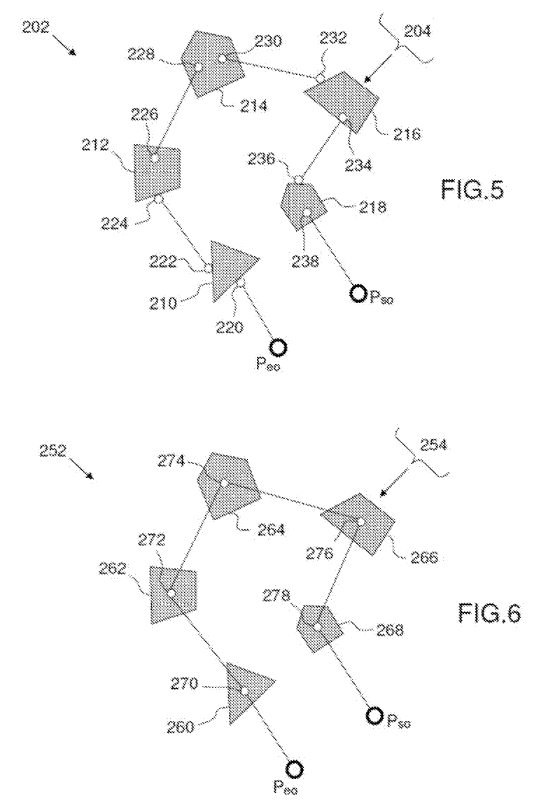

According to FIG. 6, a third example of a flight plan 252 of an aircraft for which the interzone path is minimal, determined and supplied by the assistance method 102 of FIG. 2, comprises a set 254 of first, second, third, fourth, fifth mission zones 260, 262, 264, 266, 268, the composition of which in terms of type of mission zones is representative of a third configuration in which the set 204 is all composed of mission zones 260, 262, 264, 266, 268 of second type.

All the mission zones 260, 262, 264, 266, 268 of second type each have an entry and exit access point 270, 272, 274, 276, 278.

Here, each entry and exit access point 270, 272, 274, 276, 278 is situated within their respective mission zone 260, 262, 264, 266, 268 of second type.

As a variant, all the entry and exit access points or some of them can be situated on the outline of their respective mission zone of second type.

According to the first configuration and the second configuration, the set 154, 204 of the mission zones comprises at least one mission zone of first type having an entry access point and an exit access point that are different which are both situated on the outline of said mission zone of first type, or both within said mission zone of first type, or, for one, on the outline of said mission zone of first type and, for the other, within said mission zone of first type.

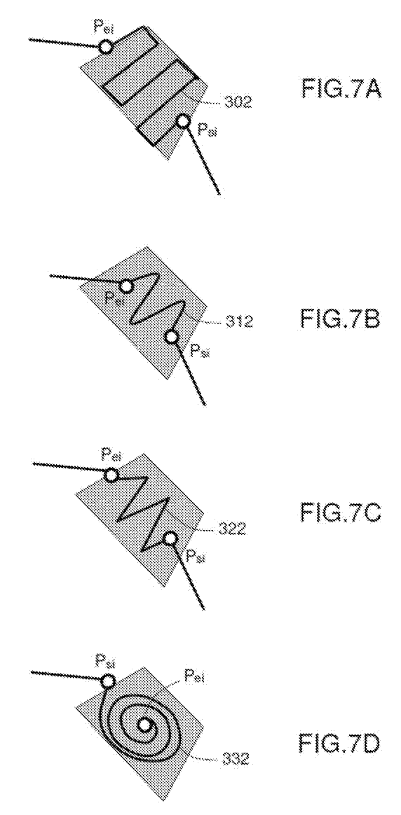

According to FIGS. 7A, 7B, 7C, 7D, and generally, each zone of first type comprises an open internal pattern 302, 312, 322, 332 of path of travel of the aircraft from the entry access point Pei to the exit access point Psi of said mission zone of first type.

The open internal pattern of a mission zone of first type can be composed of successive segments as illustrated for example in FIGS. 7A and 7D and/or as a form of a curve oscillating about a main direction as illustrated for example in FIGS. 7B and 7C, or a form of a spiral curve as illustrated for example in FIG. 7D.

The open internal patterns 302, 312, 322, 332 illustrated in FIGS. 7A, 7B, 7C, 7D are, respectively, a pattern in the form of a ladder, a pattern in the form of a portion of sinusoid, a pattern in sawtooth form and a pattern in spiral form.

According to FIG. 7A, the open internal pattern 302 in the form of a ladder is connected between an entry access point Pei and an exit access point Psi, both situated on the outline of the mission zone of trapezoidal form.

According to FIG. 7B, the open internal pattern 312 in the form of a portion of sinusoid is connected between an entry access point Pei and an exit access point Psi, both situated within the mission zone of trapezoidal form.

According to FIG. 7C, the open internal pattern 322 in sawtooth form is connected between an entry access point Pei, situated on the outline of the mission zone of trapezoidal form, and an exit access point Psi situated within the mission zone.

According to FIG. 7D, the open internal pattern 332 in the form of a spiral is connected between an entry access point Pei, situated within the mission zone of trapezoidal form, and an exit access point Psi, situated on the outline of the mission zone.

According to the first configuration and the third configuration, the set of the mission zones comprises at least one mission zone of second type having a same entry and exit access point, the entry and exit access point being situated within said mission zone of second type or on the outline of said mission zone of second type.

In particular, each mission zone of second type has a convex polygonal form, and the entry and exit access point of said zone of second type is situated within said mission zone and is the isobaric center of the vertices of its outline polygon.

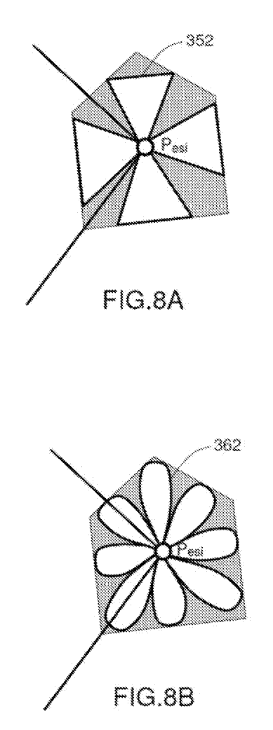

According to FIGS. 8A and 8B, and generally, each mission zone of second type comprises a closed internal pattern 352, 362 of travel of the aircraft starting from the single access point Pesi serving as entry and returning to the single access point Pesi serving as exit of said mission zone of second type.

The closed internal pattern 352, 362 of a mission zone of second type can be composed of successive segments as illustrated for example in FIG. 8A and/or has a form of a set of an integer number, greater than or equal to 2, of lobes distributed angularly over a segment of limited or omnidirectional angular aperture as illustrated for example in FIGS. 8A and 8B.

The method 102 for assisting the operator in the creation of a flight plan thus makes it possible to automatically calculate the best flight plan passing through all the mission zones, without intervention from said operator.

The calculated flight plan can be optimized more easily in terms of interzone path of shortest length:

by supplying accurate and simple geometrical characteristics of all the mission zones in which the aircraft has to travel, the geographic mission zones being separate, taken two by two, and by using an algorithm for solving the “commercial traveler” problem.

The assistance method 102 according to the invention allows the operator to dispense with the point-by-point manual input of a flight plan that is optimized in terms of interzone path and to benefit from the reliability offered by an automatic calculation.

The method 102 for assisting in the creation of a flight plan according to the invention, through its simplicity and its speed of implementation, makes it possible to automatically and flexibly modify the optimized flight plan as the aircraft moves around in the event of a change of the mission plan through the addition or modification or deletion of a mission zone. In case of modification of the mission plan, a better interzone path in terms of minimal length can be calculated accurately and rapidly to take into account the creation of a new mission zone or the modification or the deletion of an existing mission zone.

Thus, the operator assistance method according to the invention reduces the work load of said operator who no longer has to create his or her flight plan manually by himself or herself heuristically and unreliably optimizing the path traveled.

The assistance method according to the invention, executed as missions progress or during a preparatory phase of the missions allows one or more operational missions to be carried through.

The assistance method according to the invention makes it possible to take into account the changing nature of the mission plan in real time and as a function of the operational context while a mission is proceeding. Based on these missions, the flight plan of the aircraft must be calculated, then modified to follow the changes.

The computer of the assistance system proposes the best flight plan passing through all the mission zones to the operator or to the pilot, while choosing the shortest path in order to reduce the travel time.

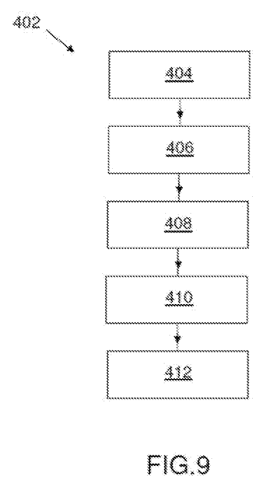

According to FIG. 9 and a particular embodiment of the method for assisting in the creation of a flight plan 102 according to the invention described in FIG. 2, a method 402 for assisting an aeronautical operator in the creation of a flight plan that is optimized in terms of length of its shortest interzone path is configured to determine an interzone path, optimized by a “nearest neighbor” algorithm, passing through all the mission zones 160, 162, 164, 166, 168, described in FIG. 3, of the set 154 of the mission zones corresponding to a first configuration.

The method 402 for assisting in the creation of a flight plan comprises first, second, third, fourth and fifth steps 404, 406, 408, 410, 412.

The first step 404, identical to the first step 104 of the assistance method 102, consists in entering into the database the geometrical characteristics of the mission zones. Here, the mission zones are modeled by polygons and the mission zones 210, 212, 214, 216, 218 respectively have a triangular form, a trapezoidal form, a pentagonal form, a quadrilateral form and a pentagonal form.

Then, in the second step 406, the entry access points and the exit access points of the mission zones are determined by the electronic mission computer.

For the mission zones of first type, the entry access points and the exit access points are known and predetermined in the database and are supplied to the electronic computer.

For the mission zones of second type, the entry and exit access points are calculated by the electronic assistance computer from the geometrical characteristics of the polygons of the mission zones of second type as being the isobaric centers Pesi, i being here equal to 1 and 5, of the corresponding polygons of the mission zones of second type, here the first mission zone 160 (i=1) and the fifth mission zone (i=5).

Assuming that the geometry of the polygons is defined in a cartesian reference frame, the coordinates Xesi, Yesi of the entry and exit access points Pesi, i equal to 1 or 5, are calculated by averaging the coordinates of the ni vertex points of the polygon of the mission zone of second type of rank i, according to the equations:

$${X}_{esi} = \frac{1}{ni} {\sum }_{k = 1}^{ni} {X}_{i} ( k )$$

$${Y}_{esi} = \frac{1}{ni} {\sum }_{k = 1}^{ni} {Y}_{i} ( k )$$

Next, in the third step 408, an interzone path of shorter length is calculated by a nearest neighbor algorithm.

The fourth and fifth steps 410, 412 are identical to the fourth and fifth steps 110, 112 of the method 102 of FIG. 2.

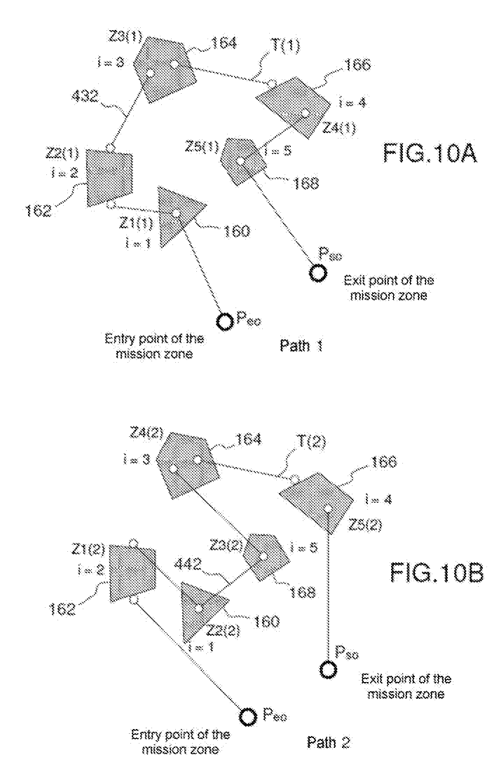

According to FIG. 10A, starting from a geographic point Pe0, accurately identified as point of departure and the entry access point of the set of the five mission zones of the mission flight plan, i varying from 1 to 5, a mission zone traveled first Z1(1) is chosen, here for example, the first mission zone 160 (i=1).

The interzone distance is then calculated between the entry access point Pe0 to the set of the mission zones and the mission zone traveled first. A first distance d(Pe0,PeZ1(1)) is then obtained.

Then, in the list of the remaining mission zones i, the mission zone Z2(1) nearest to Z1(1) is sought by calculating the distances d(PsZ1(1), Pei), here i varying within the set {1, 2, 3, 4, 5}\{1}. Only the shortest distance d(PsZ1(1), PeZ2(1)) is retained and the mission zone traveled second Z2(1) is stored, here the second mission zone 162 (i=2).

The method recommences with the following remaining mission zones, by searching for the mission zone closest to Z2(1) by the calculation of all the distances d(PsZ2(1), Pei), here i varying within the set {1, 2, 3, 4, 5}\{1,2}. Only the shortest distance d(PsZ2(1), PeZ3(1)) is retained, and the mission zone traveled third is stored. Also, the method carries on so forth step by step with the following remaining mission zones.

All the “shortest distances” d(Pe0,PeZ1(1)), d(PsZ1(1), PeZ2(1)), d(PsZ2(1), PeZ3(1)), d(PsZ5(1), Ps0) between the different polygons of the mission zones Z1(1), Z2(1), Z3(1), Z4(1), Z5(1) and the entry and exit access points Pe0, Ps0 of the set of the duly determined mission zones are stored, and a total distance dₜₒₜ(1) is calculated as the sum of said shortest distances.

Thus, once all the mission zones have been processed, a first interzone path T(1) 432 is calculated, illustrated in FIG. 10A by the nearest neighbors algorithm. This path T(1) starts with a zone chosen first as the mission zone traveled first denoted Z1(1).

According to FIG. 10B, the algorithm described to obtain the first interzone path T(1) of FIG. 10A is reiterated by choosing another mission zone traveled first, denoted Z1(2), different from the zone or zones traveled first in the path or paths already calculated, that is to say, here, the interzone path T1(1), the mission zone chosen first being, here, equal to the second mission zone 162 (i=2), and by determining, step by step from the mission zone Z1(2), the chain of the mission zones Z2(2), Z3(2), Z4(2) and Z5(2), here the first, fifth, third and fourth mission zones 160, 168, 164, 166. A second path T(2) 442 is thus determined which will be compared to the shortest path retained, that is to say, here, the first path T(1). And, so forth, the other paths T(3), T(4) and T(5) are calculated, until all the N mission zones chosen as mission zones, traveled first and connected to the entry access point of the set of the mission zones, have been used, and the interzone path is kept as the method progresses.

As the method progresses, only the interzone path out of the set of the paths T(1), T(2), T(3), T(4) and T(5) which corresponds to the shortest distance traveled is retained. The result obtained is therefore here, a set of ordered points, the entry access point of the set of the mission zones, the entry and exit access points of each mission zone, and the exit access point of the set of the mission zones.

Here, the interzone path which is determined to be the shortest is the first path T(1).

There is thus an optimized path or trajectory, capable of guiding the aircraft from one mission zone to another mission zone over all of the N mission zones to be traveled.

To obtain a complete flight plan, all that remains is to introduce the internal paths specific to each mission zone, characterized by open and/or closed internal patterns. These internal paths and patterns depend on the missions to be performed in the different mission zones.

Several different algorithms can be used to calculate the interzone path having the shortest length. A preferred algorithm is that of the “nearest neighbors” because it is simple to implement, inexpensive in terms of computation time and is of N² complexity. This algorithm offers good performance levels when the number of entry and exit access points to be traveled is not very great, which is the case in the operational context envisaged.

The method for assisting the operator in the creation of a flight plan according to the invention can be implemented in application software of “mission” type, embedded on an avionics computer, the objective of which is to assist the operator in defining the flight plan of an aircraft from a set of mission zones to be traveled.

The missions targeted are in particular of search and rescue, communication relay, tactical navigation and/or surveillance types.

As a variant, the application software of “mission” type that makes it possible to implement the assistance method according to the invention can also be deployed in a touch tablet of EFB (electronic flight bag) type to add operational mission functionalities to the avionics of the cockpit and of the aircraft.

The carrier aircraft affected by the invention are included in the set formed by helicopters, airplanes and dirigible balloons.

As a variant, the application software of “mission” type, that makes it possible to implement the assistance method according to the invention, can also be used for the management of unmanned aircraft or drone missions. In this case the management of the mission is performed on the ground, from a ground control station GCS. The assistance method and system according to the invention makes it possible to assist the piloting operator of the drone, in the creation of the trajectory of the piloted aircraft as a function of the missions that said aircraft must accomplish, by constructing, simply, reliably and flexibly, a flight plan of the drone which minimizes the length of the interzone path traveled. On the console of the operator, a human-machine interface is configured to supply an optimized flight plan of the drone based on mission data transmitted by a command center.

It should be noted that the flight plan that is optimized in terms of distance amounts to a flight plan optimized in terms of time when the wind is zero.

Generally, the invention described above can be applied to any system involving zones to be gathered together and to be covered, and can therefore be applied also to a boat or a land vehicle.

1. A method for assisting an aeronautical operator in the creation of a flight plan of an aircraft passing through a set of predetermined geographic mission zones, implemented by an operator assistance system comprising an electronic assistance computer, an associated human-system interface IHS and a database;
the method for assisting in the creation of the flight plan comprising a set of steps consisting in:
in a preliminary first step, supplying a set of at least two separate geographic mission zones, characterized geometrically by their convex forms and their placement in a two-dimensional geographic reference frame, and supplying, in the same reference frame, the geographic coordinates of an entry access point and of an exit access point of the set of the mission zones, the entry and exit access points of the set being separate from each of the mission zones; then
in a second step, determining, respectively for each mission zone, an entry access point and an exit access point of the mission zone, the entry and exit access points associated with a mission zone being able to be separate or merged; then
in a third step, determining, using a shorter path algorithm, an interzone path from the entry access point to the exit access point of the set of the mission zones which connects, in series and without loop, all the mission zones by their entry and exit access points, and the length of which is minimal,
the method for assisting in the creation of the flight plan being wherein:
the set of the mission zones comprises at least one mission zone of first type having an entry access point and an exit access point that are different which are both within said mission zone of first type, or, for one, on the outline of said mission zone of first type and, for the other, within said mission zone of first type; and/or,
the set of the mission zones comprises at least one mission zone of second type having a same entry and exit access point, the entry and exit access point being situated within said mission zone of second type or on the outline of said mission zone of second type.

2. The method for assisting in the creation of a flight plan according to claim 1, wherein
the total number of mission zones is an integer number N greater than or equal to 2, and the interzone path the length of which is minimal is configured to link, in a chain, the entry access point of the set of the mission zones to the exit access point of the set of the mission zones through a succession of N−1 intermediate segments linking in series the N mission zones without looping back to a mission zone from their respective entry access point to their respective exit access point; and
the third step uses a shorter path algorithm passing through all the entry and exit points of the mission zones, determined in the second step from the entry access point of the set of the mission zones to the exit access point of the set of the mission zones.

3. The method for assisting in the creation of the flight plan according to claim 2, wherein
the shorter path algorithm is included in the set of the algorithms formed by:
the “brute force” algorithm, and
the genetic algorithms, and
the “ant colonies” algorithm, and
the nearest neighbor algorithm.

4. The method for assisting in the creation of the flight plan according to claim 1 wherein
the total number of mission zones is an integer number N greater than or equal to 2, and
each mission zone identified by an identification index i, i varying from 1 to N, has a polygonal form having a number of sides nᵢ and a number of vertices nᵢ.

5. The method for assisting in the creation of the flight plan according to claim 1, wherein
the set of the mission zones comprises at least one mission zone of first type having an entry access point and an exit access point that are different which are situated
both within said mission zone of first type, or
for one, on the outline of said mission zone of first type and, for the other, within said mission zone of first type.

6. The method for assisting in the creation of the flight plan according to claim 5, wherein
each zone of first type comprises an open internal pattern of travel of the aircraft from the entry access point to the exit access point of said mission zone of first type.

7. The method for assisting in the creation of the flight plan according to claim 6, wherein the open pattern of at least one mission zone of first type is composed of successive segments and/or has a form of a curve oscillating about a main direction or a form of a spiral curve.

8. The method for assisting in the creation of the flight plan according to claim 1, wherein
the set of the mission zones comprises at least one mission zone of second type having a same entry and exit access point, the entry and exit access point being situated within said mission zone of second type or on the outline of said mission zone of second type.

9. The method for assisting in the creation of a flight plan according to claim 8, wherein
each mission zone of second type has a convex polygonal form, and
the entry and exit access point of said zone of second type is situated within said mission zone and is the isobaric center of the vertices of its outline polygon.

10. The method for assisting in the creation of a flight plan according to claim 9, wherein
each mission zone of second type comprises a closed internal pattern of travel of the aircraft starting from the single access point serving as entry and returning to the single access point serving as exit of said mission zone of second type.

11. The method for assisting in the creation of a flight plan according to claim 10, wherein the closed internal pattern of at least one mission zone of second type is composed of successive segments and/or has a form of a set of an integer number, greater than or equal to 2, of lobes distributed angularly over a segment of limited or omnidirectional angular aperture.

12. The method for assisting in the creation of a flight plan according to claim 1, wherein
the total number of mission zones is an integer number N greater than or equal to 2, and
all the mission zones are mission zones of first type each having an entry access point and an exit access point that are different which are situated
both within said mission zone of first type, or
for one, on the outline of said mission zone of first type and, for the other, within said mission zone of first type.

13. The method for assisting in the creation of a flight plan according to claim 1, wherein
the total number of mission zones is an integer number N greater than or equal to 2, and
all the mission zones are mission zones of second type having, for each, a different entry and exit access point, the entry and exit access point of any mission zone of second type being situated within said mission zone of second type or on the outline of said mission zone of second type.

14. The method for assisting in the creation of a flight plan according to claim 1, comprising
a fourth step of display, in which a display displays the flight plan determined in the third step, and/or
a fifth step in which the flight plan, determined in the third step, is transferred to a flight management system having a high security level.

15. A system for assisting an aeronautical operator in the creation of a flight plan of an aircraft passing through a set of predetermined geographic mission zones, comprising an electronic assistance computer for the aeronautical operator, an associated human-system interface IHS and a database;
the database and/or the human-system interface being configured to, in a preliminary first step, supply the electronic assistance computer with a set of at least two separate geographic mission zones, characterized geometrically by their convex forms and their placement in a two-dimensional geographic reference frame, and supply, in the same reference frame, the geometrical coordinates of an entry access point and of an exit access point of the set of the mission zones, the entry and exit access points of the set being separate from each of the mission zones;
the electronic assistance computer and/or the database is or are configured to, in a second step, determine, respectively for each mission zone, an entry access point and an exit access point of the mission zone, the entry and exit access points associated with a mission zone being able to be separate or merged; and
the electronic assistance computer is configured to, in a third step following the first and second steps, determine, using a shorter path algorithm, an interzone path from the entry access point to the exit access point of the set of the mission zones which connects, in series and without loop, all the mission zones by their entry and exit access points, and the length of which is minimal,
the system for assisting the aeronautical operator in the creation of a flight plan being wherein
the set of the mission zones comprises at least one mission zone of first type having an entry access point and an exit access point that are different which are both within said mission zone of first type, or, for one, on the outline of said mission zone of first type and, for the other, within said mission zone of first type; and/or,
the set of the mission zones comprises at least one mission zone of second type having a same entry and exit access point, the entry and exit access point being situated within said mission zone of second type or on the outline of said mission zone of second type.

16. The system for assisting an aeronautical operator in the creation of a flight plant of an aircraft according to claim 15, wherein
the human-system interface is configured to, in a fourth step, display through a display the flight plan determined in the third step, and/or the assistance computer is configured to, in a fifth step, transfer the flight plan, determined in the third step, to a flight management system having a high security level.
